(19) United States
(12) Patent Application Publication
(10) Pub. No.: US 2018/0157386 A1
(43) Pub. Date: Jun. 7, 2018

(54) System and Method for detection, exploration, and interaction of graphic application interface

(71) Applicant: Jiawen Su, Sunnyvale, CA (US)

(72) Inventor: Jiawen Su, Sunnyvale, CA (US)

(73) Assignee: Jiawen Su, Sunnyvale, CA (US)

(21) Appl. No.: 15/613,160

(22) Filed: Jun. 3, 2017

Related U.S. Application Data
(60) Provisional application No. 62/430,344, filed on Dec. 5, 2016.

(51) Int. Cl. G06F 3/0482

(52) U.S. Cl. CPC G06F 3/0482; H04L 67/02

(57) ABSTRACT

A GUI (Graphic User Interface) application recognition and interaction system enables application-agnostic and device-agnostic recognition and interaction through use of image and text pattern recognition. The GUI device includes a GUI client application that provides wide range of functionalities. The GUI device includes smartphones, tablet computers, laptop and desktop computers, game consoles, and other GUI-enabled processor-based devices, and virtual machines (VM) and devices provided by VM hypervisors. The GUI application recognition and interaction system leverages artificial intelligence, machine learning, and other algorithms and methods to enable automatic recognition of common user interface elements and page types such as menus, login, status and error, and associated application flows in a GUI application, and enable interaction with the GUI app based on recognized application flows information, configurations, and previously automatically detected application flows.

### CROSS REFERENCE TO RELATED APPLICATIONS

This application claims the benefit of U.S. Provisional Application No. 62/430,344, filed Dec. 5, 2016, which is incorporated by reference herein in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The embodiments described herein relate generally to exploration and control of Graphic User Interface (GUI) applications, and Artificial Intelligence.

### BACKGROUND

Graphic user interface (GUI) becomes a dominant way users interact with applications on modern computing devices, such as smartphones, tablets, game consoles, and computers. GUI devices have become an import part of our lives. People often carry mobile devices and use variety of GUI-based mobile applications. As of today, there are over 1 million GUI apps in application stores for iPhones and Android phones. GUI applications for mobile devices and computers is a large segment of economy. Developers of GUI applications design graphic interface interaction as the primary and often the only way to access an application (app).

In addition to purpose-built stand-alone GUI applications, Web browser is a popular graphic interface gateway to access many websites both on mobile devices and desktops, which have rich graphic interface, even video and audio. These are additional examples of GUI applications.

These GUI applications or websites are designed primarily for human interactions. Some of them provide programming APIs that another application can invoke and integrate with; many don't provide APIs. For those with APIs, invocation of APIs requires programming, debugging, and testing efforts.

A human can intuitively use GUI applications, including mobile apps, web pages, and desktop apps, often without prior training. The interactions are usually based on common image and text pattern elements and actions, such as menu, button, input box, scroll or scroll bar. In addition, the application's screen image and text display changes, as response to user actions such as click, scroll, data input, and device and location movement, helping a user further understand and interact with the application. Image and text contents such as error message or error image on screen are feedbacks to user's actions and help a user to understand GUI application's functionality.

Inputs to GUI applications generally include several ways. Touch screen in mobile devices detect multiple touches, each touch comes with a position (measured in x and y pixel distance relative to left-top position of the screen) and length and strength of the touch. Mouse-based input provides information about mouse movement and press of mouse buttons. Keyboard, either virtual one shown on touch screen or physical one, can facilitate data input and control of the GUI application. The input method extends to voice-based input, either in the form of raw voice or converted text via speech recognition. Responses to input actions can help a user understand and interact with UI elements, e.g. confirm a designed button behavior by applying a click to see expected screen changes.

### SUMMARY

This application invents an application and device agnostic method and system to automatically recognize menu image and text patterns in graphic user interface applications, based on artificial intelligence, machine learning and other algorithms in image and text pattern recognition. The system intelligently and automatically detects layouts of screen image and recognizes common user interface elements, patterns, layouts, and application flows of a GUI application, such as menu structures. It also recognizes and identifies many screen or page types such as login/sign-up pages, content browsing, and action confirmation and error display.

The system includes detection of the response to user interface action such as click applied to a menu element, which will further confirm recognition of actionable UI components that will drive application flows and also result in additional screens generated from application outputs. After the system automatically recognizes a GUI application's apps flow, the system can take a high-level instruction from a user and drive application action sequence in order to complete the instruction.

### BRIEF DESCRIPTION OF THE DRAWINGS

FIG. 1 is a block diagram of an example GUI application recognition and interaction environment, under an embodiment.

FIG. 2 is a first example screenshot of a mobile application running on a GUI device, showing 4 recognizable UI elements and available actions, under an embodiment.

FIG. 3 is a second example screenshot of a Web application, showing recognizable UI elements and actions, under an embodiment.

FIG. 4 is an embodiment of an example online recognition and action system implemented in the context of GUI app system, under an embodiment.

FIG. 5 is an embodiment of an example recognition batching training system implemented, under an embodiment.

FIG. 6 is a flowchart describing an example operation of online recognition and action system, under an embodiment.

FIG. 7 is a flowchart describing an example use of GUI application recognition and action system from an external action request, under an embodiment.

FIG. 8 is a flowchart describing an example operation of recognition batch training system, under an embodiment.

FIG. 9 is a flowchart describing an example operation of recognizing a visual UI element in a target image using template match algorithm, under an embodiment.

FIG. 10 is a diagram describing an example design of neural network designed to recognize visual UI element patterns and texts in a target image, under an embodiment.

FIG. 11 is an example screenshot of a mobile application, showing sign-in page, which is required to enter main application area, under an embodiment.

FIG. 12 is a diagram describing another example design of neural network designed to recognize visual UI element patterns and texts in a target image, under an embodiment.

FIG. 13 is an example screenshot of image and text acquisition tool UI Animator for Android GUI application and device, showing a screenshot image, screen structure description XML, and an XML node detail, under an embodiment.

### DETAILED DESCRIPTION

Embodiments of the invention will now be described. It should be understood that such embodiments are provided only by way of example and to illustrate various features and principles of the invention, and that the invention itself is broader than the specific examples of embodiments disclosed herein.

The individual features of the particular embodiments, examples, and implementations disclosed herein can be combined in any desired manner that makes technological sense. Moreover, such features are hereby combined in this manner to form all possible combinations, permutations and variants except to the extent that such combinations, permutations and/or variants have been explicitly excluded or are impractical. Support for such combinations, permutations and variants is considered to exist in this document.

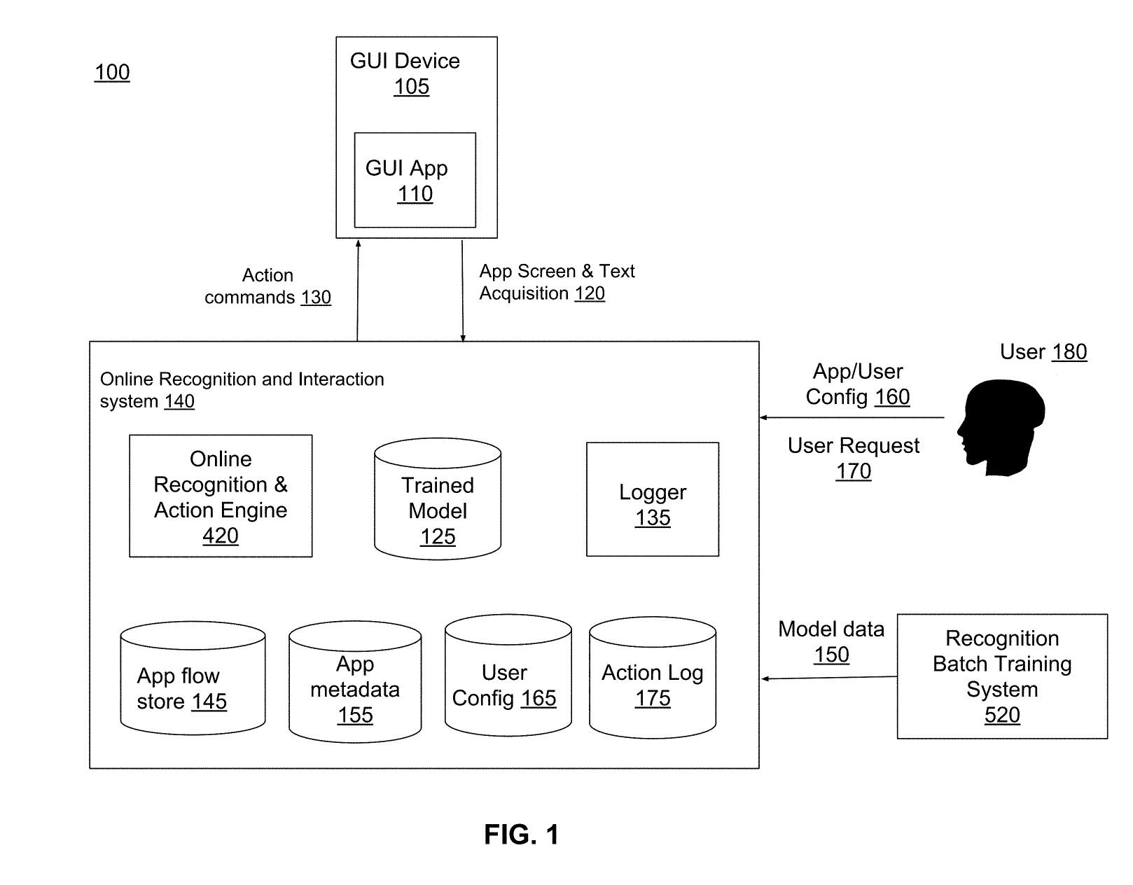

FIG. 1 is a block diagram of an example GUI application recognition and interaction environment 100, under an embodiment. The GUI application recognition and interaction environment 100 of an embodiment comprises a GUI device 105 including a GUI application 110 that executes on a processor of the user device with which the user interacts, an Online Recognition and Interaction System 140 for recognizing and interacting with the GUI app, Recognition Batch Training system 520, which provides trained Model Data 150, App/User Configuration data 160 from the user 180, User Request 170 from the user 180, and external human user 180.

In one embodiment, GUI device 105 is a physical device such as smartphone, tablet, game console, and laptop and desktop computer; in another embodiment, GUI device 105 can be a virtual execution environment simulating or emulating device, such as a virtual machine running on top of a hypervisor.

The Online Recognition and Interaction system 140 is a system comprising of an Online Recognition & Action Engine 420, Trained Model 125, Logger 135, App Flow store 145, App Metadata 155, User Config 165, and Action Log 175. The system 140 acquires screen graphic and text data from GUI App 110 via acquisition process 120. The acquired data will be processed by the Online Engine 140 and recognized into app flow and saved to App flow store 145 during exploration phase. In execution mode, the Online Engine 140 will interpret the data within context of executing to an instruction or task, deciding next step or report result/status back if reaching end of the task. The Online Engine 140 performs processing and recognition based on Trained Model 125, App metadata 155, and User Config data 165. Actions and activities by Online Engine 140 will be saved to Action Log 175 by Logger 135.

Generally, the Online Engine 420 understands common graphic representations of screenshot and text from GUI app 110 and has the ability to recognize and decompose screenshots into menus/icons and other content navigation control structures and content elements based on computer vision and text processing capability. A variety of algorithms for such recognitions are used. Under an embodiment, one method known as “Deep Neural Network (DNN)”, uses many hidden layers of neural units between the input and output layers for feature extraction and transformation. Each successive layer uses the output from the previous layer as input. DNNs learn multiple levels of representations that correspond to different levels of abstraction, the levels form a hierarchy of concepts. DNN designs for object detection and parsing generate compositional models where the object is expressed as a layered composition of image primitives. The higher layers enable composition of features from lower layers. A DNN can be trained with the standard backpropagation algorithm.

After recognition of application navigation and content structure from Application screenshot and text, The Online Engine 420 can send Action Command 130 to GUI app 110. Examples of Action Command 130 include click, scroll, and other multi-touch interactions commonly available to touch-screen GUI app; or mouse move and click to mouse-based GUI app. Action Command 130 will be input to GUI App 110 and often causes change of screens from GUI app 110, in turn App Screen and Text 120 will acquire the new screens and serve as new input to the Online System 140. This process will be repeated in exploration phase until all flows in the application are recognized and saved to App flow store 145.

Capabilities to facilitate App Screen & Text Acquisition 120 and Action Commands 130 with GUI Device 105 and GUI App 110 are generally available today. Under an embodiment, Android UI Animator tool can interact with both physical mobile devices and emulated virtual devices to capture device and app screenshot image and screen structure in the form of a tree of hierarchical UI elements in XML format. Android UI Animator can also send action such as click to screen in an application.

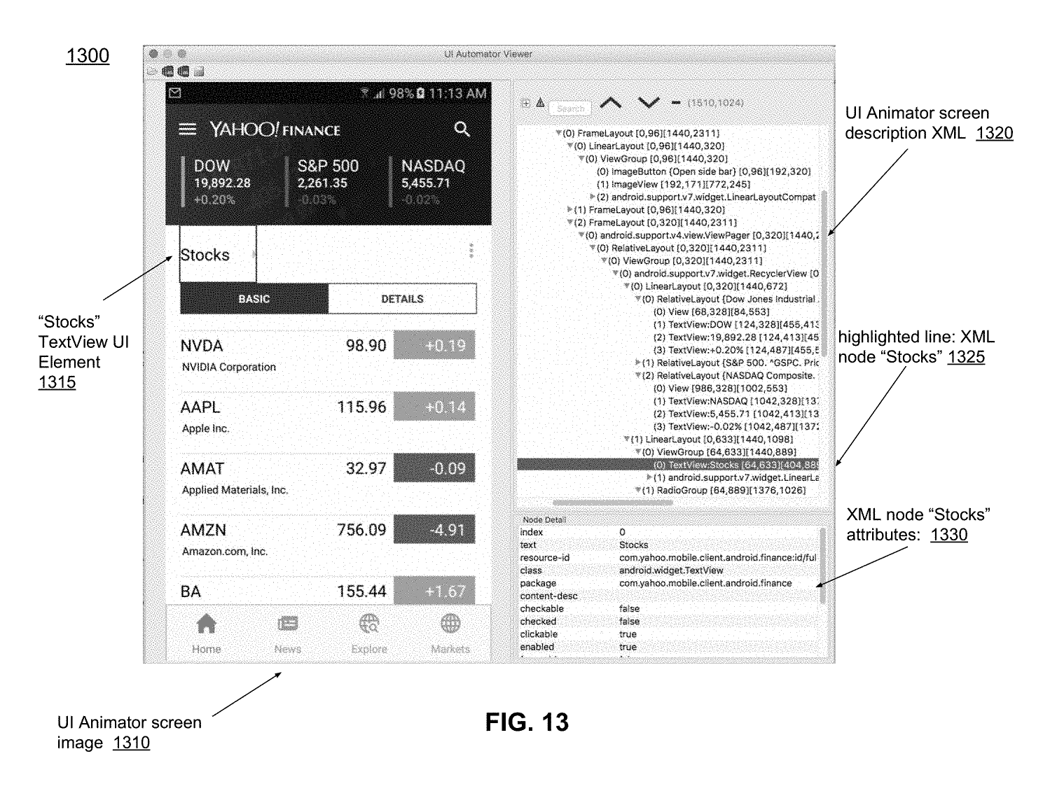

FIG. 13 is an example screenshot of image and text acquisition tool UI Animator for Android GUI application and device, showing a screenshot image 1310, screen structure description XML 1320, and an XML, node detail 1330, under an embodiment. In screenshot image 1310, “Stocks” Textview UI element 1315 is highlighted. The corresponding description XML 1325 is also highlighted. Detail of “Stocks” XML node attributes is shown in 1330 area, where we can see text attribute “Stocks” and “clickable” attribute “true”. On some GUI devices such as Android, both image and text data are acquired by the same tool. On other GUI devices, only image data can be acquired, text will be recognized from image instead.

Under another embodiment, iOS Instrument Automation and XCUnitTest framework allows interactions with iOS application, including reading screen content and perform actions to the app. Under yet another embodiment, VNC remote desktop system is available on Windows, MacOS, and Linux desktop operations systems to capture remote device and app screen and send actions to remote device and app, either physical device or virtual.

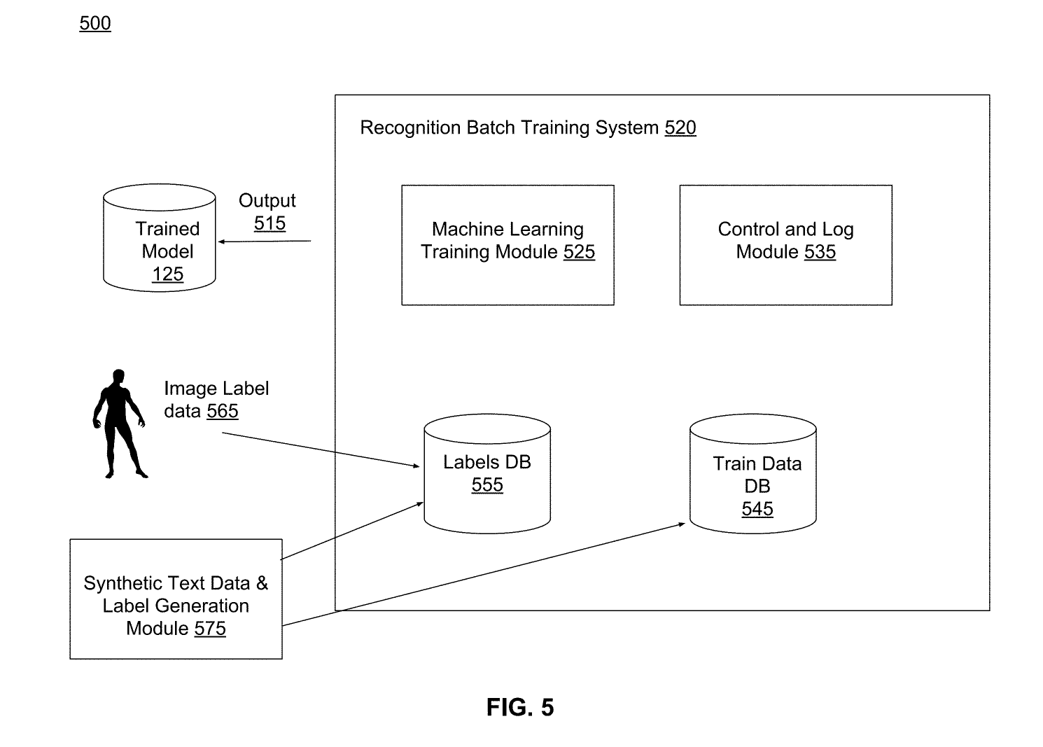

The Recognition Batch Training System 520 generates Model Data 150 regularly. Model data 150 is stored to Trained Model storage 125. One embodiment of Batch Training system 520 is illustrated in FIG. 5 and described later in this document.

User Config data 165 comes from User 180 via App/User Config 160. Examples of User Config data include login credential such as username and password. Under one embodiment, Application metadata 155 comes from User 180; under another embodiment, Application metadata 155 comes from public Application Store, such as Apple App Store and Google PlayStore. Examples of Application Config data are application name, category, description of the application.

The User Request 170 comes from the User 180. The request comes in high-level user-understandable action instruction. Under one embodiment, an example is buy Panasonic big-screen TV for up to $2000 from Amazon. The Online Recognition and Interaction System 140 will then leverage recognized App flow store 145, App metadata 155, and User Config 165, generating a sequence of individual application actions such as click and keyboard input and send to GUI App Amazon for execution. At execution of each action, the Online System 140 will recognize response or result data from the GUI App 110 in real-time and decide next step. The final result will then be reported to the user 180. Under another embodiment, a user request 170 simply exercise application use cases for the purpose of testing the GUI App 110.

Logger 135 writes many types of activities in the system to Action Log 175. Examples of activities include user configuration by User 180, recognition activity from Online Engine 420, model input activity from Model Data 150, and execution steps from User Request 170.

Although the detailed description herein contains many specifics for the purpose of illustration, anyone of ordinary skill in the art will appreciate that many variations and alterations to the following details are within the scope of the embodiments described herein. Thus, the following illustrative embodiments are set forth without any loss of generality to, and without imposing limitations upon, the claims set forth herein.

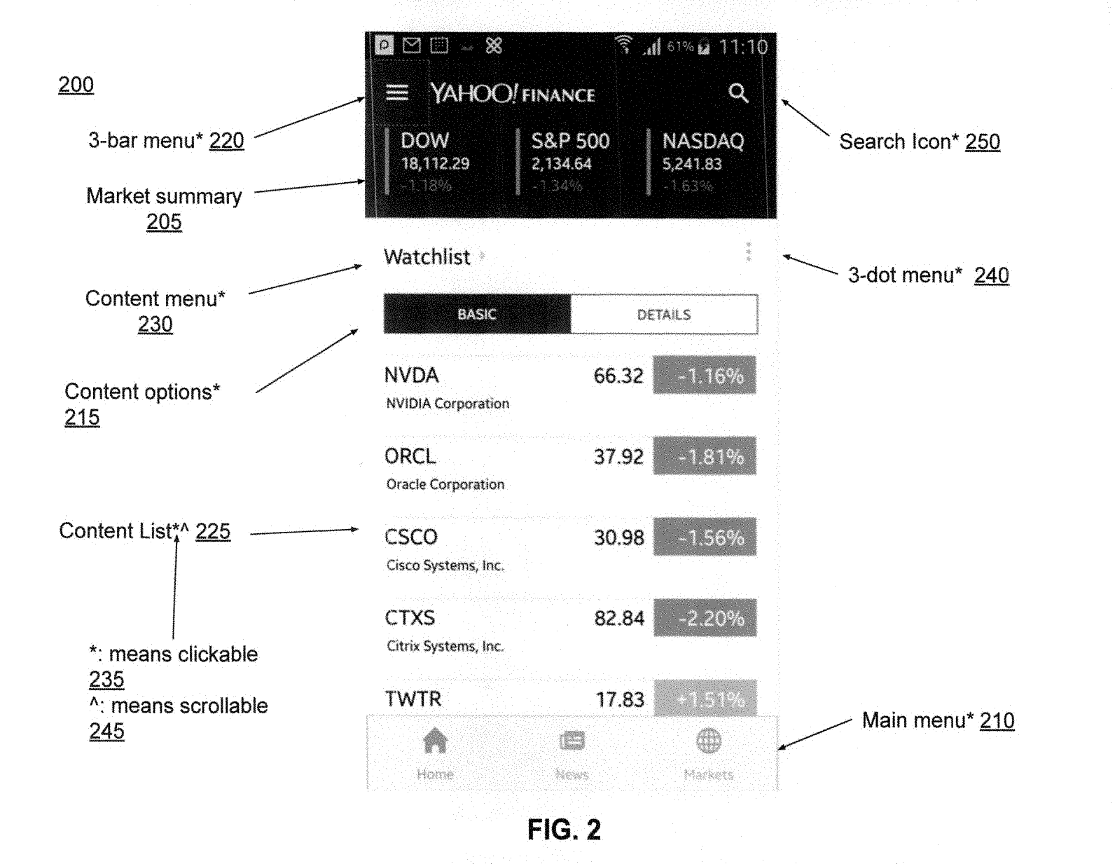

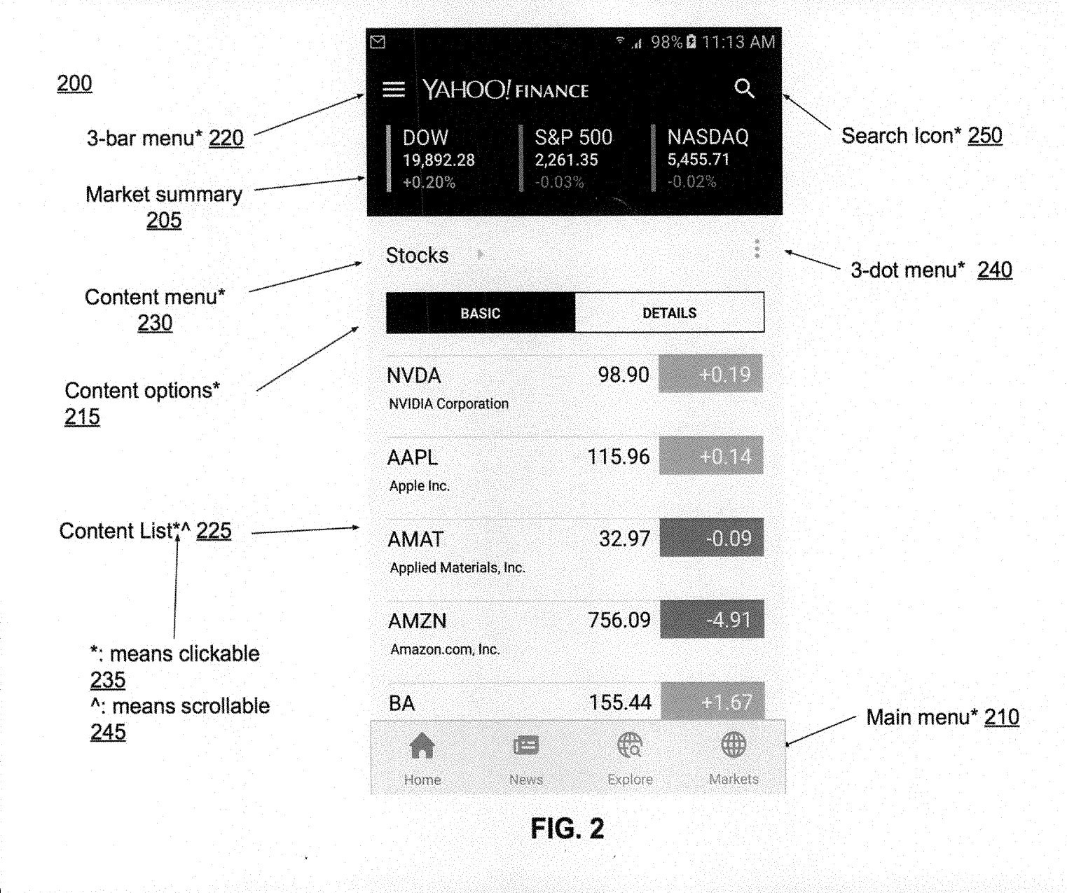

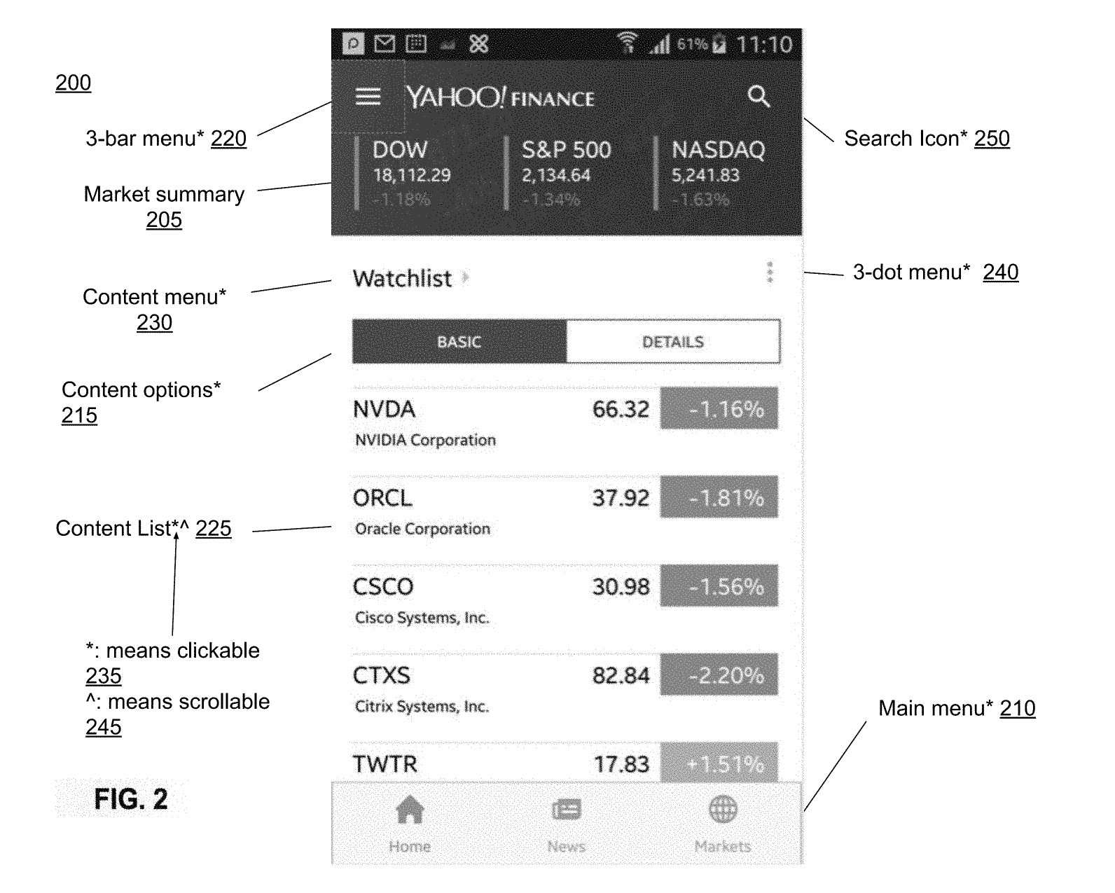

FIG. 2 is a first example screenshot 200 showing “Yahoo Finance” mobile GUI App 110 on GUI Device 105, under an embodiment. The example screenshot 200 includes examples of a variety of visual menu elements and their positions recognized by Online Recognition and Interaction System 140: at the bottom of screen, 210 is a main bottom menu; at the top of screen, 220 is a 3-bar menu; 205 is Market summary area; 215 is content options; 230 is content menu; 225 is content list; 240 is a 3-dot menu; 250 is a search icon. At each UI element, various types of interaction actions are available: 235 shows click action and 245 shows scroll action.

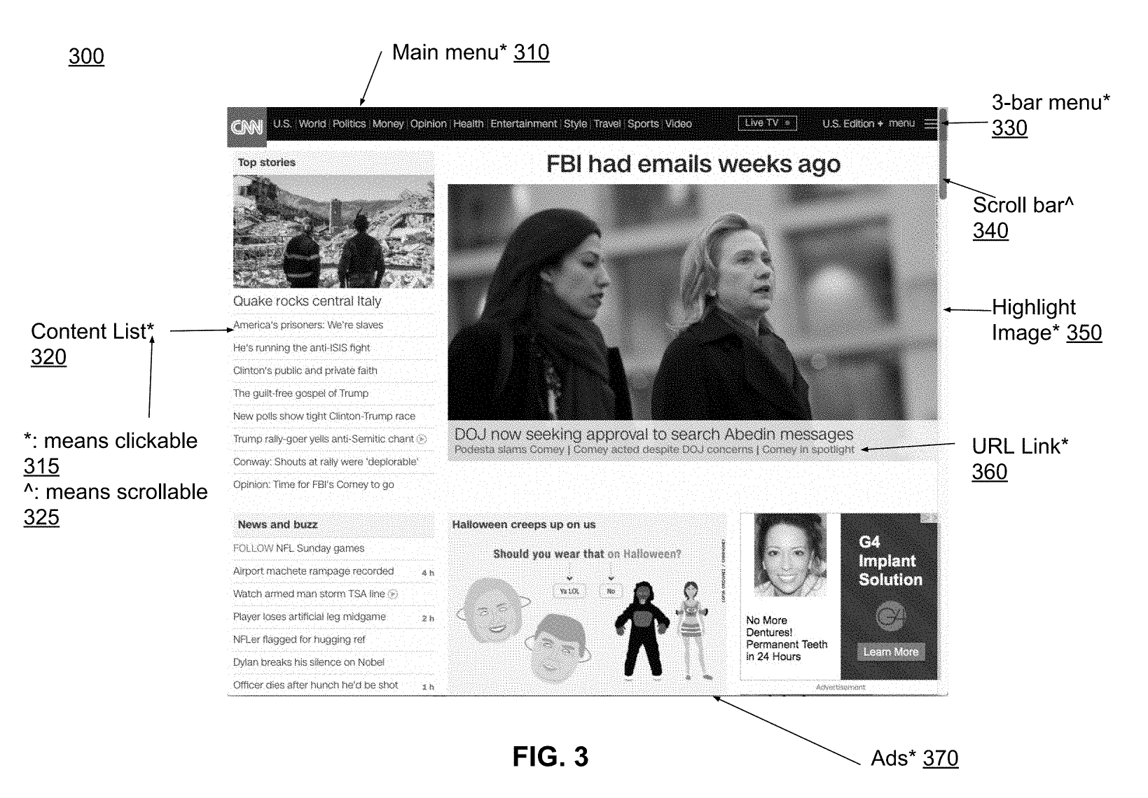

FIG. 3 is a second example screenshot 300 showing “CNN” web GUI App 110 on GUI Device 105, under an embodiment. The example screenshot 300 includes examples of a variety of visual elements recognizable by Online Recognition and Interaction System: 310 is a Main (top) menu, defining overall navigation of “CNN” web App; 320 shows a content list. At the top right corner; 330 is 3-bar menu item; 340 is a scroll bar; 350 is a clickable image; 360 is a URL link; 370 is an advertisement image and text. At each UI element, various types of interaction actions are available: 315 shows click action and 325 shows scroll action.

In addition to the recognition of visual elements and their positions as illustrated in FIGS. 2 and 3, the Recognition and Interaction System 140 generates a list of Action Commands 130. Examples of “click” actions that can be applied in FIG. 2 are main menu 210, 3-bar menu 220, content menu 230, 3-dot menu 240, and search icon 250. Since both visual elements and their positions are recognized, click action can be sent to the element's specific position in the screen. In addition, “scroll” action can be applied to Content List 225 area. In one embodiment of touch screen user device, finger scroll action can be applied. In another embodiment of mouse-based user device, scroll-wheel on a mouse can be applied for “scroll” action. Similar action commands can be generated for web GUI App, as shown in screenshot 300.

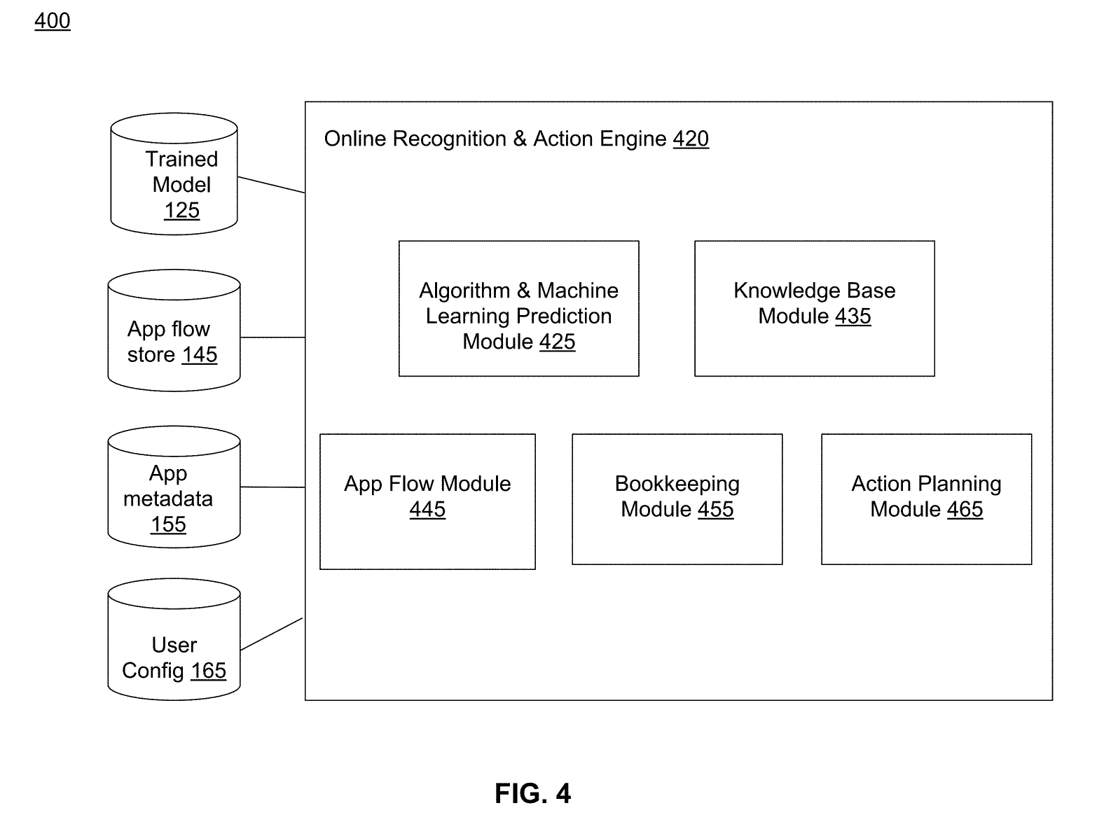

FIG. 4 is a block diagram of an example online recognition & action engine, under an embodiment. The Online Recognition and Action Engine 420 comprises of Algorithm & Machine Learning Prediction Module 425, Knowledge Base Module 435, App Flow Module 445, BookKeeping Module 455, and Action Planning Module 465.

The Prediction Module 425 includes a variety of effective AI and vision algorithms such as KNN (K nearest neighborhood), SVM (Support Vector Machine), DNN (deep neural network), Logistics Regression, Decision Tree, and meta combination algorithms. Generally, these algorithms use Trained Model 125 and generate results or predictions from input data. Meta combination algorithms combine multiple machine learning algorithms to produce better result than individual algorithm. The Knowledge Base Module 435 encodes human or expert knowledge in the system. The human knowledge generally comes in the form of rules with combination of context conditions and resulting adjustments or actions. When context conditions are met, the rule is activated and the adjustments or actions will be executed. Expert knowledge rules can either act alone to generate result or adjust machine learning prediction to produce better result

The App Flow Module 445 keeps track of both macro and micro composition of GUI App flows. Macro flow tracks overall use cases, while micro flow tracks individual steps within a flow. The Action Planning Module 465 is responsible for two separate tasks: 1) in the app recognition context, generate a list of exploration action commands and their priority, send to GUI app for further recognition of app flows 2) in the action context, consult App Flow Store 145 and decompose high-level instruction into detailed actionable step-level action. An example is a high-level instruction “Buy Samsung 4K TV for up to $1000 from Amazon”. The Action Planning module 465 will generate individual app screen click and input actions to interact with Amazon app and result in an executed purchase order for a Samsung TV. The Bookkeeping Module 455 does various statistics collecting and used more by The Knowledge Base Module 435. One example is counting how many times a rule has been matched and activated, which can be used for further improvement and tuning of rules.

Without loss of generality, menu structures are not limited to examples shown here. After showing examples and variations of menu structures, this application now describes a system and method that recognize these menu structures.

FIG. 5 is a block diagram of an example recognition engine batch training system, under an embodiment. The Recognition Batch Training System 520 comprises of Machine Learning Training Module 525, Control and Log Module 535, Train Data DB 545, and Labels DB 555. The Machine Learning Train Module 525 reads both Train Data DB 545 and Labels DB 555, iterates over data for often large number of iterations and optimize model parameters for specific learning goal. An example of optimizing goal is to minimize classification error. The training process generally takes long time, hours and even days. The Control and Log Module 535 monitors batch training process and stops current training and output trained model parameters via Output 515 to Trained Model store 125.

The Train Data DB 545 houses different types of trained data, which can be in very large size (e.g. hundreds of gigabytes or terabytes). Examples of trained data are screenshot images and app description text data. Under an embodiment, some train data are not labeled by human, they are consumed by unsupervised machine learning algorithms. Some train data are labeled by humans via process Label data 565. Under another embodiment, trained data and labels are generated by computer program Synthetic Text Data & Label Generation Module 575 automatically. Supervised machine algorithms rely on both data and their labels. An example of labeling training data is to identify visual element and its position in a screenshot, such as 3-bar menu element 220 illustrated in FIG. 2.

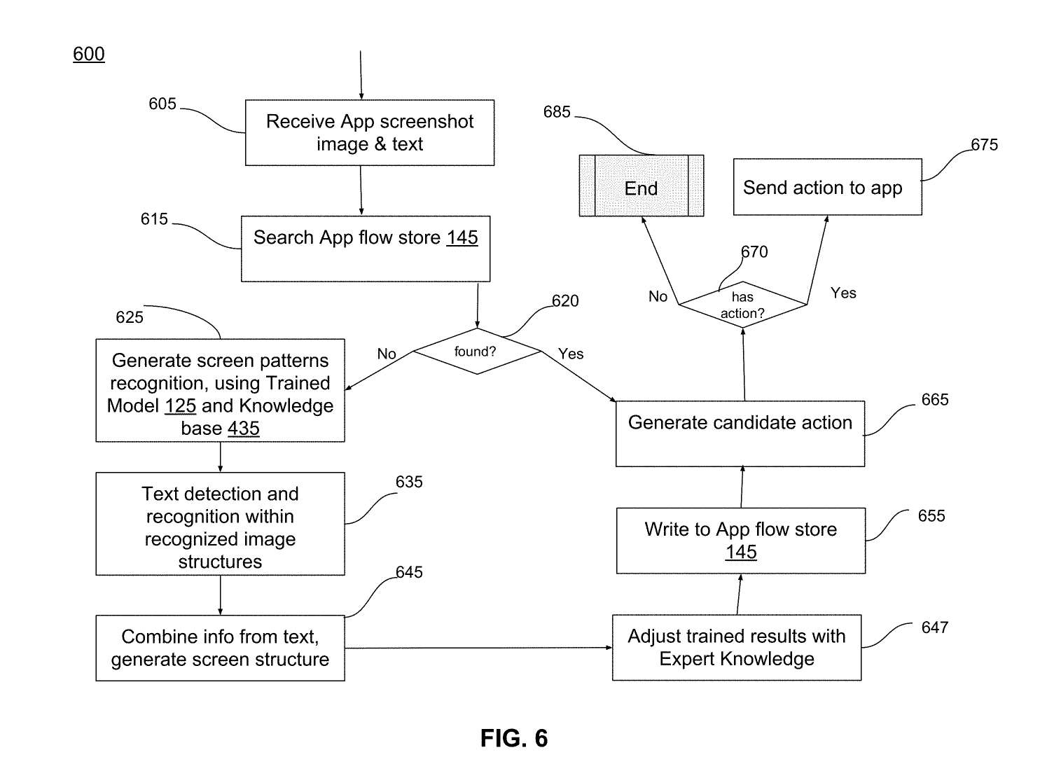

FIG. 6 is a flowchart describing example recognition operation of the Online Recognition and Interaction Engine 140 in recognizing App screenshot and generating action commands to further recognize app flows, under an embodiment. In step 605, the Engine 140 receives App screenshot image and text from GUI App 110 via App Screen & Text Acquisition 120, under an embodiment. Under another embodiment, text data and location may not be available from acquired input and they will be recognized directly from image. In next step 615, the Engine 140 searches App flow store 145 to see whether the flow has been recognized earlier, followed by decision step 620. If the app flow has not been processed before and hence not found, the Engine 140 will start in step 625 screen patterns recognition, using Trained Model 125 and Knowledge base 435. Step 625 employs multiple algorithms and combines results from those algorithms to achieve better result than any individual algorithm. The screen image pattern recognition is combined with 635 text processing to generate screen structures in step 645. Text detection and process in step 635 is needed even when text data are acquired from Input 120, because Input 120 may not acquire all text in an image and step 635 will acquire remaining text data. If no text data is available from input, step 635 will directly recognize all text data and location from image. The newly recognized info is then adjusted with expert knowledge from human in step 647, then stored to App flow store 145 in step 655. An example of expert knowledge adjustment is location of a top menu happens near top of a screen and commonly spans entire width of a screen—if a detected top menu is close to edge of screen, it will be extended to the edge. Based on newly recognized info, in step 665 additional list of action commands are generated and prioritized into work queue. An example command is to send click action to a menu item at the specific menu location on a screen, which will result in new screenshot and text data.

In decision step 620, if the screenshot has been found processed before, the Engine 140 will skip recognition step since it has been done before. Instead, the Engine 140 will go to prioritized work queue and try to pick next command in the work queue. In step 670, if there is more action command in the queue, next prioritized command will be sent to GUI app 100 in step 675. If there is no more action command in the queue, the entire app has been recognized and processed and this is the end of an app exploration phase in step 685.

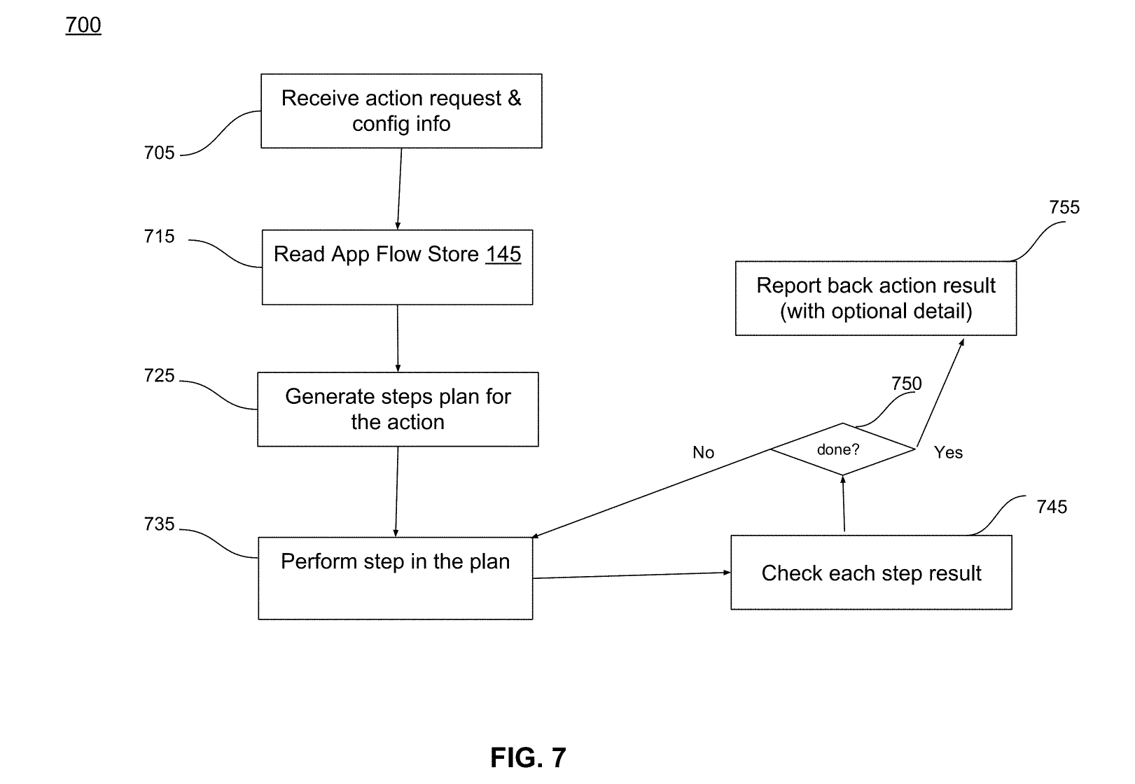

FIG. 7 is a flowchart describing example interaction operation of the Online Recognition and Interaction Engine 140 in executing external command request, e.g. from a user, under one embodiment. The Engine 140 receives 705 action request and config information. The config information can be user login and password to the GUI Device 105 and GUI App 110, only need to be given once and will be stored for future use. An example of action request is to buy Samsung TV from Amazon app.

The Engine 140 first reads 715 app flow info from App Flow Store 145. Based on App flow info, the Engine will generate 725 a sequence of app screen click and input action steps as execution plan. Then the Engine 140 will perform 735 each step in the execution plan. For each action step, the Engine will check the individual step result 745. If the entire action plan is not completed, the Engine 140 will continue to execute next step 735. If the entire action plan is done in step 750, the Engine 140 will report final execution result 755. Some step may result in an error and cannot continue the execution plan, e.g. login error, the error will be reported as well.

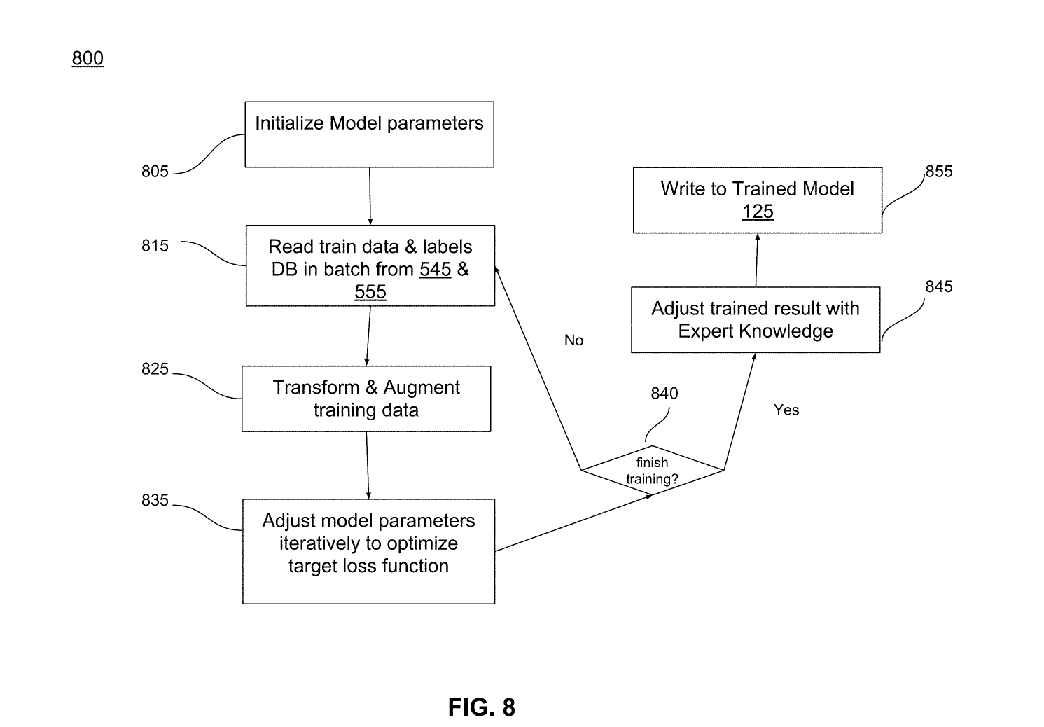

FIG. 8 is a flowchart describing an example operation of Recognition Batch Training System 520, under an embodiment. The Machine Learning Training Module 525 first initializes machine learning model parameters in step 805. Model initialization techniques can have material impact on final prediction accuracy. For Deep Neural Network machine learning algorithms, it's common to train machine model first with large public dataset such as ImageNet. The trained model parameters from public dataset are used as initial model parameters before training on own domain dataset.

The Training Module 525 then read train data and labels from DB 545 and 555 in step 815. Machine learning algorithms have different ways to use train data and labels. Some divide entire dataset into many smaller batches. To improve final prediction accuracy, each batch may be randomly sampled from the dataset. Dataset augmentation techniques can be applied to further improve model results. For example, rescaled and flipped images from original training image data are often added to training data. Some machine learning models require particular data size. An example is the image size for Deep Neural network (DNN). The Machine Learning Module 525 applies these data transformation and augmentation in step 825.

Machine Learning Module 525 performs main training in step 835. Generally, the Machine Learning Module 525 goes through training data and labels many times. Model parameters will be optimized at each iteration. The Control and Log module 535 adjusts learning ratio at each iteration and decides whether training is completed in decision step 840. Batch training for many machine learning models take a long time, it's common to take days to complete. After batch training is over, trained result is first adjusted with expert knowledge from human in step 845, then Control and Log module will write model parameters data in step 855 to Trained Model 125.

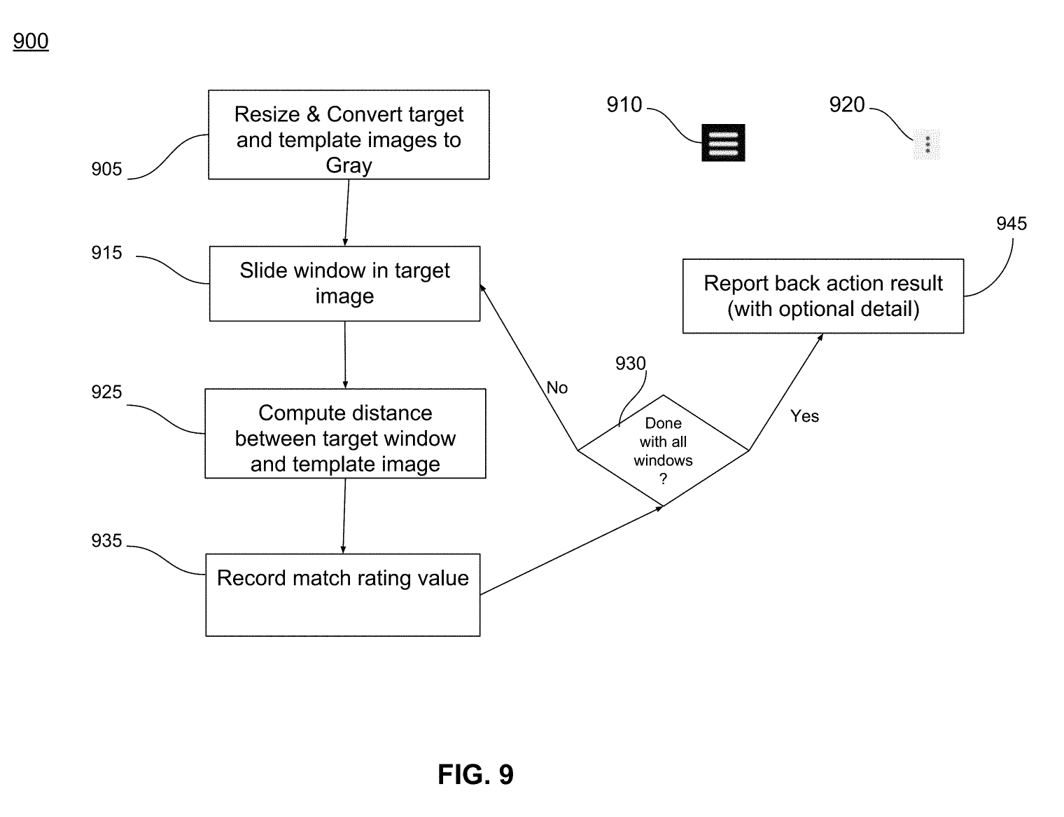

FIG. 9 is a flowchart describing an example operation of the Algorithm & Machine Learning Prediction Module 425 recognizing a visual element in a target image using template match algorithm, under an embodiment. The template image 910 is an example template image for 3-bar menu 215 in FIG. 2. The template image 920 is an example template image for 3-dot menu 250 in FIG. 2.

The template match algorithm in Prediction Module 425 first resizes and converts both target image and template image in step 905. An example is to convert both to into gray color. To improve accuracy, multiple sizes and scales of target image will be used for template image matching. The Prediction Module 425 then selects starting point, denoted by (x, y) pixel position in the target image relative to left-top position. Starting point will move by step and eventually covers entire target image, this is called slide window in step 915. The slide window itself has same width and height dimensions as template image.

After a window is selected, the Prediction Module 425 computes in step 925 the distance between the slide window portion of the target image and template image, both are represented in matrix of pixel value. Under one embodiment, geometric distance formula is used to compute the distance. Geometric distance summarizes squared difference at each pixel, as illustrated in numerator in EQ. 1 below. R(x,y) is the match rating value for the slide window at (x,y) position of the target image. Match rating value R(x,y) is then computed by normalizing to value range between 0 and 1 by applying a denominator.

$$R ( x , y ) = \frac{{\sum }_{{x}^{′} , {y}^{′}} {( T ( {x}^{′} , {y}^{′} ) - I ( x + {x}^{′} , y + {y}^{′} ) )}^{2}}{\sqrt{{\sum }_{{x}^{′} , {y}^{′}} {( {T ( {x}^{′} , {y}^{′} )}^{2} \cdot {\sum }_{{x}^{′} , {y}^{′}} I ( x + {x}^{′} , y + {y}^{′} ) )}^{2}}} \qquad EQ . 1$$

T(x1,y1): pixel value in range 0 to 1 at location (x1,y1) in the template image;

I(x2,y2): pixel value in range 0 to 1 at location (x2,y2) in the target image

The Template Match algorithm has a model parameter called threshold. An example threshold value is 0.4. If the computed distance is below the threshold, it's a match with template image, otherwise it's not a match. The threshold parameter controls how strictly or loosely a match will be. The Prediction Module 425 records in step 935 match rating score, then continues the sliding window process 930 by move starting point to next position in the target image. The size of move is controlled by another parameter step-size. If there is more slide window in target image, the Prediction Module 425 will repeat steps from 915 to 935. After the Prediction Module 425 completes the entire target image, it will report in step 945 template match result. Good accuracy can be achieved with this template match algorithm, in experiments the detection accuracy for a test set of images is higher than 80%.

Under another embodiment, match rating value can use the following co-relation equation, as illustrated in EQ. 2:

$$R ( x , y ) = \frac{{\sum }_{{x}^{′} , {y}^{′}} ( T ( {x}^{′} , {y}^{′} ) - I ( x + {x}^{′} , y + {y}^{′} ) )}{\sqrt{{\sum }_{{x}^{′} , {y}^{′}} {T ( {x}^{′} , {y}^{′} )}^{2} \cdot {\sum }_{{x}^{′} , {y}^{′}} {I ( x + {x}^{′} , y + {y}^{′} )}^{2}}} \qquad EQ . 2$$

Different equations work differently for training data. One equation can work better than another one with some templates, depending on data domain and templates. Selecting a best match rating equation for a particular dataset is one of tuning tasks for the algorithm.

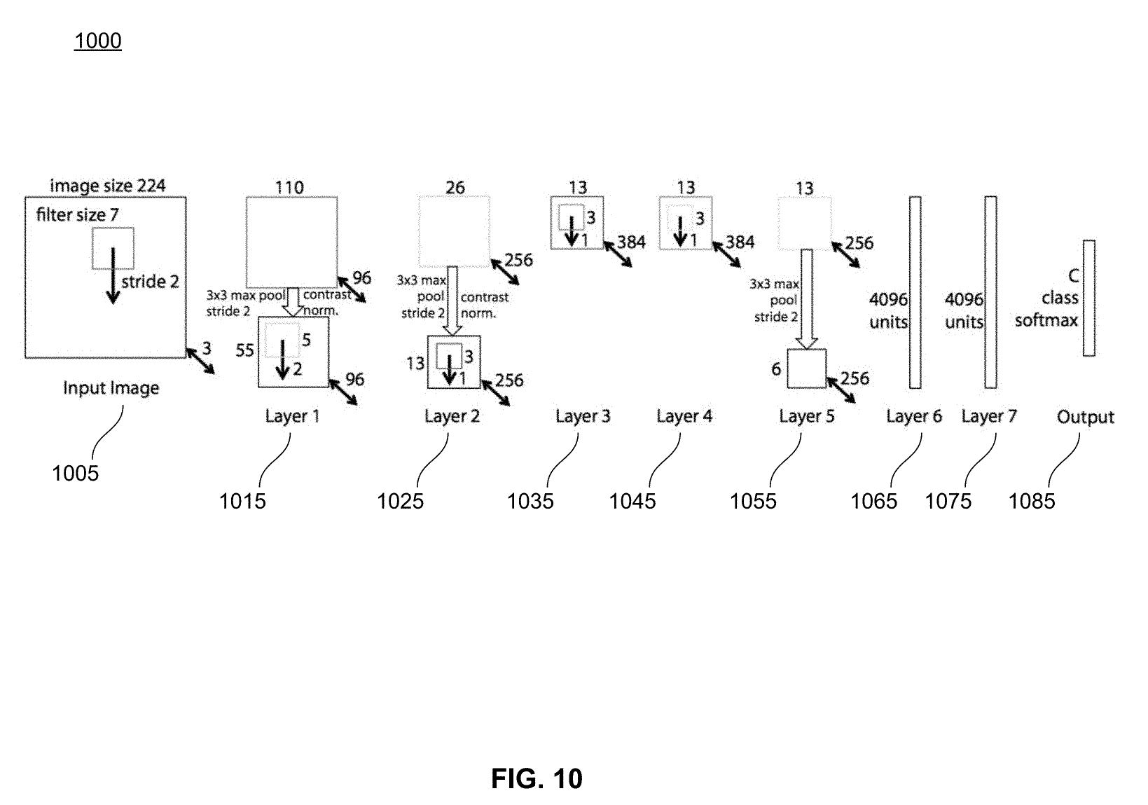

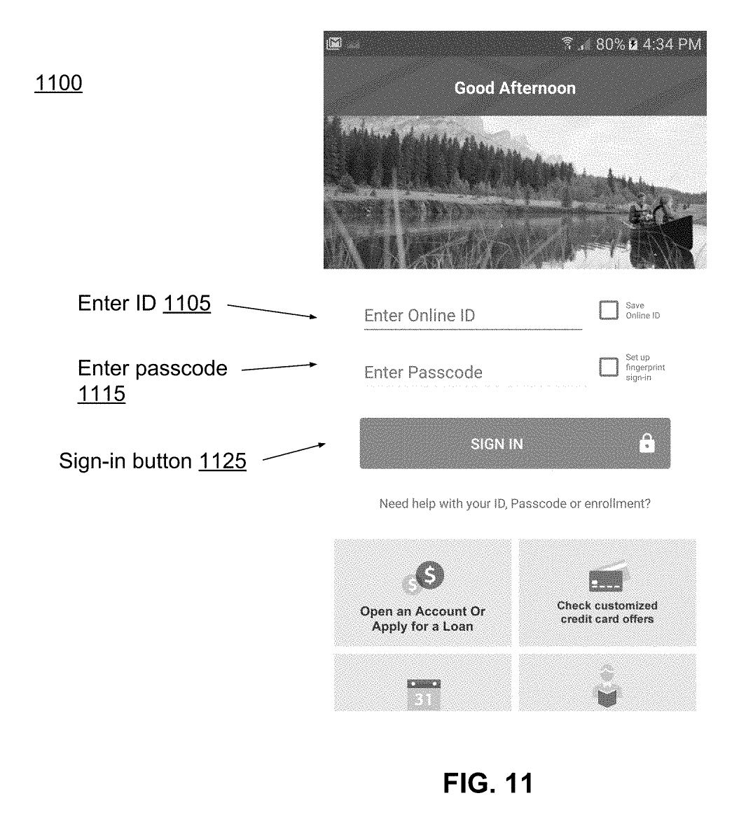

Under an embodiment, FIG. 10 is an example design of Deep Neural Network algorithm in the Prediction Module 425 to detect objects inside target image (both location and object category). Examples of objects relevant to this application are visual UI elements page types, and text data. The example neural network in FIG. 10 is adapted from reference neural network design by Matthew Zeiler and Rob Fergus (ZF-network, please refer to their 2013 research paper https://arxiv.org/abs/1311.2901). It's selected and described here due to its simplicity, speed, and reasonable prediction accuracy. Without loss of generality, more sophisticated neural network design can be applied. In other embodiments, neural networks of hundreds of layers are employed.

Description of example neural network 1000 uses common deep neural network terminologies, as shown in Table 1.

TABLE 1

| Terminology | Description |
|---|---|
| Image Input | Hold raw pixel value of an image, in this example an |
| (example: | image of width 480, height 480, and with 3 color |
| 480 × 480 × 3) | channels RGB. Before detection, raw image will be |
| | converted to image input dimension required by an |
| | algorithm. |
| conv layer | conv (convolutional) layer will compute output of |
| example: 3 × 3 | neurons that are connected to local regions (such as |
| stride 1 filters | 3 × 3, in this example) in input, next neuron will move |
| 16 (denoted as | region by a stride size (such as 1). If number of filters |
| filters 16 | is not stated, it's same as the previous layer. |
| 3 × 3/1) | |
| RELU layer | RELU(rectified learning unit) will apply an elementwise |
| | activation function, such as max(0, x) threshold at 0. |
| | Each conventional layer is followed by a RELU layer. |
| | It will not be explicitly described in the rest of |
| | application |
| max pool layer | Will perform a down-sampling operation along the |
| | spatial dimensions. Can be done using N × N stride 2 |
| | (N >= 2) max operation, where only the largest |
| | value among NxN elements will be kept. |
| FC layer | Will compute class scores, result in 1 × 1 × C-classes, |
| (fully- | where each of the C classes number correspond to class |
| connected) | score. |

ZF-network has 7 hidden layers, 1005 to 1075 in FIG. 10 denotes each of hidden layers and input/output layer in the network. It's common for more recent neural networks to have hundreds of layers. Table 2 describes detail of each layers. In public PASCAL 2012 dataset (http://host.robots.ox.ac.uk/pascal/VOC/voc2012/, about 16500 images in 20 classes of objects), ZF-network achieves over 75% accuracy in classification. Combined with object location proposal methods such as sliding window described earlier in 915 of FIG. 9, ZF-network achieves over 55% accuracy in object or visual elements recognition (both object and locations of the object).

TABLE 2

| Layer | Operations |
|---|---|
| Input | Apply CONV 7 × 7 stride 2 with 96 filters, RELU |
| (224 × 224 × 3) | |
| Layer 1 | Max pool 3 × 3 stride 2, then CONV 5 × 5 stride 2 |
| | with 256 filters, RELU |
| Layer 2 | Max pool 3 × 3 stride 2, then CONV 3 × 3 stride 2 |
| | with 384 filters, RELU |
| Layer 3 | CONV 3 × 3 stride 1 with 384 filters, RELU |
| Layer 4 | CONV 3 × 3 stride 1 with 256 filters, RELU |
| Layer 5 | Max pool 3 × 3 stride 2 |
| Layer 6 | FC with 4096 units, RELU |
| Layer 7 | FC with 4096 units, RELU |
| Output (1 × 1 × C) | Softmax classification with C classes |

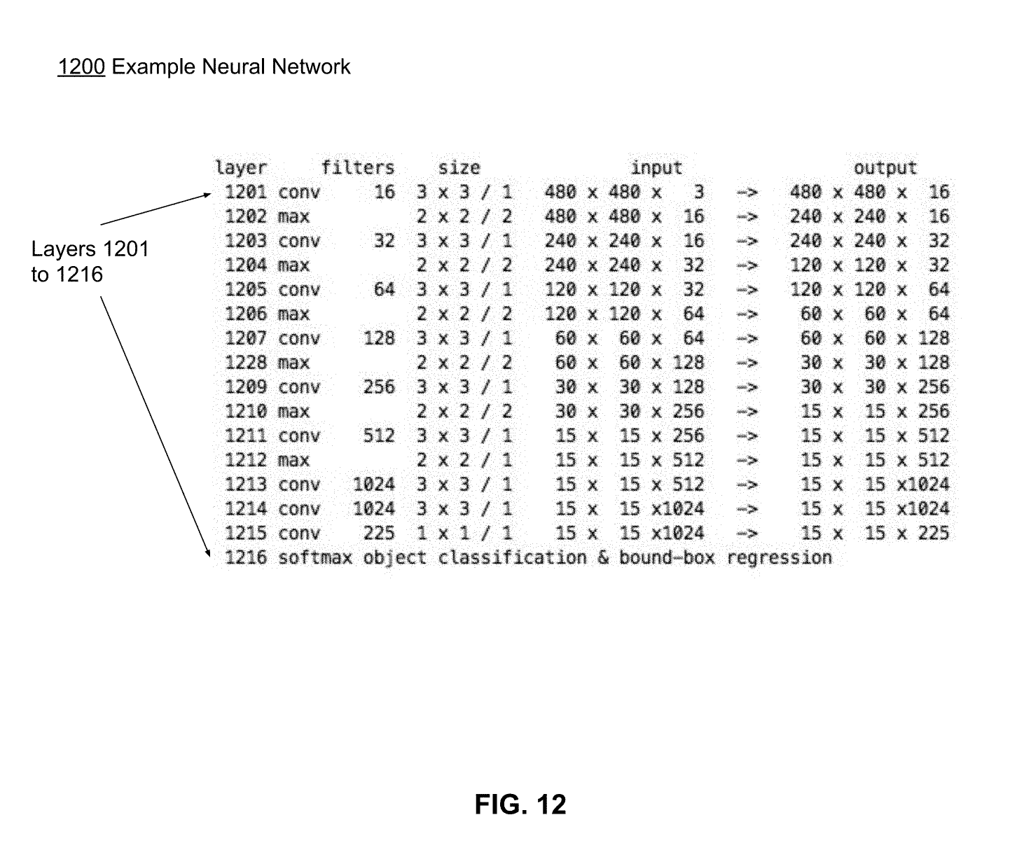

Under an embodiment, FIG. 12 is another example design of Deep Neural Network algorithm in the Prediction Module 425 to detect objects inside target image (both location and object category). Neural network 1200 in FIG. 12 has 15 hidden layers, 1201 to 1215 in FIG. 12 denotes each of 15 hidden layers. Layer 1216 is the output layer in the network. It's common for more sophisticated neural networks to have hundreds of layers. Neural Network 1200 is fully conventional and does not employ traditional fully-connected layer. Object classification (softmax) and location recognition in layer 1216 is directly applied over conventional layer 1215. In FIG. 12, there are 4 different attributes for each neural network layer, represented in 4 columns: 1) filters 2) size, where m×n/s stands for local region m×n and step size s 3) input, from previous layer (or raw image in first layer 1201) 4) output. Layer 1201 takes raw image as input. Layer 1201 to layer 1215 employs 9 conventional layers (layer 1201, 1203, 1205, 1207, 1209, 1211, 1213, 1214, and 1215) and 6 max pool layers (layer 1202, 1204, 1206, 1208, 1212, 1212). Layer 1216 applies softmax classification for object class and regression for object location bound box dimension.

In public PASCAL 2012 dataset (http://host.robots.ox.ac.uk/pascal/VOC/voc2012/, about 16500 images in 20 classes of objects), Neural Network 1200 achieves over 50% accuracy in object or visual elements detection (both object classes and locations of the object). More sophisticated neural network design and better location proposal method will result in higher accuracy.

Neural network 1200 combines object recognition and localization in a single end-to-end network. Layer 1215 outputs 15×15×225 values. It divides input image into 15×15 or 225 grids. Each grid has an anchor position located at central point of the corresponding grid of screen. Under an embodiment, each grid is assigned 9 anchor boxes to predict objects and location of the object (in the form of bound box). Choices of anchor boxes are based on dataset distributions and are picked with combinations of scales and aspect ratios. Under an embodiment, 3 sales and 3 aspect ratios are used and resulted in 9 combinations, or 9 anchor boxes.

In one embodiment of 20 object classes, each anchor box generates 25 output values, representing of 20 conditional probabilities for each of 20 object classes, 4 dimensions of the bound box on the screen (in the form of central local point (x,y) of the bound box and width and height of the bound box), and 1 probability pᵢ that the bound box is an object. Under an embodiment, each grid is assigned 9 anchor boxes, total 9×25=225 values are produced at each grid.

During training, each ground truth box (ground truth box are those labeled by human or generated by computer programs) is matched to the default anchor box with the best overlap. Multiple anchor boxes can be matched (called positive-match) as long as they overlap higher than a threshold (an example of threshold is 0.5). Under an embodiment, training objective is to minimize multi-task loss function illustrated in EQ. 3:

$$L ( \{ {p}_{i} \} , \{ {t}_{i} \} ) = \frac{1}{{N}_{cls}} {\sum }_{i} {L}_{cls} ( {p}_{i} , {p}_{i}^{*} ) + λ \frac{1}{{N}_{reg}} {\sum }_{i} {p}_{i}^{*} {L}_{reg} ( {t}_{i} , {t}_{i}^{*} ) . \qquad EQ . 3$$

In EQ.3, i is the index of an anchor in a training batch and pᵢ is the predicted probability that the anchor has an object and the probability for each class of object. Ground truth binary class label pᵢ* is assigned to the anchor, it's 1 if the anchor matches an object, and is 0 if the anchor does not match an object. tᵢ is the predicted 4 bound-box parameters, and tᵢ* is the ground-truth box for a positive-match anchor. The classification loss L_{cls} is log loss over number of classes and object vs not object. For the regression loss L_{reg}, square error loss over bound box parameters are used. The term pᵢ* controls regression loss is only enabled if the anchor is positive-match. λ is a regulation parameter controlling contribution of L_{cls} and L_{reg} in overall loss, its value is picked based on optimization of prediction accuracy

In another embodiment, Neural network 1200 is applied to detect location of text words in an image, where there is only 1 class of “text” object. For best accuracy, some of tuning parameters are adjusted for text dataset. Example parameters are scales and aspect ratios. After locations of text words are recognized, standard OCR(optical character recognition) software, either open source or commercial one, can detect text with high accuracy (over 80%.) An example of OCR software and library is tesseract-ocr (more information can be found at https://github.com/tesseract-ocr.) Under another embodiment, more advanced character recognition algorithms can be applied for better accuracy.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

While the invention is described through the above exemplary embodiments, it will be understood by those of ordinary skill in the art that modification to and variation of the illustrated embodiments may be made without departing from the inventive concepts herein disclosed.

What is claimed is:

1. A computer-implemented method for detecting and recognizing visual UI elements, page types, texts, and application flows from graphic user interface (GUI) application, comprising:
receiving screen image, and screen structure description information if available, from a GUI application running on a device;
detecting presence of UI elements, page types, and texts and determining a score, location, and text data of each presence, based on pre-trained model data;
detecting and recognizing menu item list from a response screen image after an action is performed on the GUI application on a device;
updating application flow store with recognized UI elements and texts;
determining a set of interaction actions from recognized UI elements and texts;
recognizing and grouping application flows from UI iterations on individual screens;
providing the set of interaction actions to the device and GUI application;
receiving indication of a user request to perform tasks facilitated by the GUI application on the device;
determining action sequences to serve the user's instruction, based on recognized GUI application flows;
providing instructions to the device for facilitating the action sequences to serve the user's request;
providing execution result information of the user request to the user;
producing trained model data from training data.

2. The method of claim 1, wherein the device comprises a portable computing device, desktop computer, game console, and virtual machine environment hosted by a computing device.

3. The method of claim 1, wherein the GUI application comprises a native GUI application on a computing device, and graphic website presented by a Web browser.

4. The method of claim 1, wherein the visual UI elements and page types comprise graphic icons, text entries, or combination of graphic icons and text entries.

5. The method of claim 1, wherein text data comprise text in all common human written languages, including English, Spanish, French, German, Chinese, Japanese, Arabian, and other written languages.

6. The method of claim 1, wherein comprising adjusting scores and locations of a set of visual UI elements and page types available on a screen image based on a template matching score.

7. The method of claim 1, wherein comprising adjusting scores and locations of a set of visual UI elements and page types available on a screen image based on screen content structure description data, including hierarchy screen element trees, dimension, and text data and location on screen, if available.

8. The method of claim 1, wherein comprising adjusting scores and locations of a set of visual UI elements and page types available on a screen image based on text data and location on screen recognized directly from image, if available, using trained models from training data.

9. The method of claim 1, wherein comprising adjusting scores and locations of a set of visual UI elements and page types available on a screen image based on expert knowledge from human experts.

10. The method of claim 1, further comprising:
periodically performing training operation to obtain an updated model data
periodically update and add training data;
training data are obtained from real-world application;
training data are labeled by human.

11. The method of claim 10, wherein the training data including labels are automatically generated by computer programs, commonly referred as synthetic data generation.

12. The method of claim 10, wherein the training data comprising both image and text data.

13. A computer readable storage medium comprising stored instructions executable by one or more processors, the instructions when executed by the one or more processors causing the one or more processors to:
receiving screen image, and screen structure description information if available, from a GUI application running on a device;
detecting presence of UI elements, page types, and texts and determining a score, location, and text data of each presence, based on pre-trained model data;
detecting and recognizing menu item list from a response screen image after an action is performed on the GUI application on a device;
updating application flow store with recognized UI elements and texts;
determining a set of interaction actions from recognized UI elements and texts;
recognizing and grouping application flows from UI iterations on individual screens;
providing the set of interaction actions to the device and GUI application;
receiving indication of a user request to perform tasks facilitated by the GUI application on the device;
determining action sequences to serve the user's instruction, based on recognized GUI application flows;
providing instructions to the device for facilitating the action sequences to serve the user's request;
providing execution result information of the user request to the user;
producing trained model data from training data.

14. The computer readable storage medium of claim 13, further comprising adjusting scores and locations of a set of visual UI elements and page types available on a screen image based on a template matching score.

15. The computer readable storage medium of claim 13, further comprising adjusting scores and locations of a set of visual UI elements and page types available on a screen image based on screen content structure description data, including hierarchy screen element trees, dimension, and text data and location on screen, if available.

16. The computer readable storage medium of claim 13, further comprising adjusting scores and locations of a set of visual UI elements and page types available on a screen image based on text data and location on screen recognized directly from image, if available, using trained models from training data.

17. The computer readable storage medium of claim 13, further comprising adjusting scores and locations of a set of visual UI elements and page types available on a screen image based on expert knowledge from human experts.

18. The computer readable storage medium of claim 13, further comprising:
periodically performing the training operation to obtain an updated model data
periodically update and add training data;
training data are obtained from real-world application;
training data are labeled by human.

19. The computer readable storage medium of claim 18, wherein the training data including labels are automatically generated by computer programs, commonly referred as synthetic data generation.

20. The computer readable storage medium of claim 18, wherein the training data comprising both image and text data.
